(19) United States
(12) Patent Application Publication
(10) Pub. No.: US 2002/0000537 A1
(43) Pub. Date: Jan. 3, 2002

(54) Humidity adsorbent agent and humidity adsorbent element using thereof

(76) Inventors: Hiroki Daikaku, Chiba (JP); Takeya Kobayashi, Tokyo (JP); Teruji Yamazaki, Kanagawa (JP)

Correspondence Address: FLYNN, THIEL, BOUTELL & TANIS, P.C., 2026 Rambling Road, Kalamazoo, MI, 49008-1699, US

(21) Appl. No.: 09/863,671

(22) Filed: May 23, 2001

(30) Foreign Application Priority Data
May 25, 2000 (JP) 2000-154700

(51) Int. Cl. C09K 3/00; C01B 33/36; C01F 7/00

(52) U.S. Cl. 252/194; 423/700; 423/713

(57) ABSTRACT

To provide a humidity adsorbent agent having duplicating advantages of hydrophilic zeolite and silica gel, and a humidity adsorbent element using thereof, a humidity adsorbent agent is used an alumino-silicate which is replaced a part of sodium to Lanthanide in a hydrophilic zeolite. A humidity adsorbent element is constituted that is supported the agent on a carrier comprised of inorganic fiber paper.

### BACKGROUND OF THE INVENTION

The present invention relates to an improvement of a humidity adsorbent agent and a humidity adsorbent element using thereof.

### DESCRIPTION OF RELATED ART

As a humidity adsorbent element incorporated into a regeneration type dehumidifier or a full heat exchanger, it is known materials that supported a humidity adsorbent agent, such as silica gel, zeolite or the like on a surface of carrier comprised of an inorganic fiber manufacturing a honeycomb likewise. In these, the humidity adsorbent element used silica gel as a humidity adsorbent agent are used mainly, by means of having a highly humidity adsorbing characteristics, in addition to desorbing a humidity easily and a cheapness.

In conventionally, the humidity adsorbent element is constituted so as to be supporting on a surface of honeycomb rotor comprised of an inorganic fiber manufactured honeycomb likewise. Periphery area part of the honeycomb rotor is constituted in dividedly an adsorbing zone for adsorbing humidity, a desorbing zone for desorbing the adsorbed humidity and recovering an adsorbing capability of the honeycomb rotor and a cooling zone for quenching the honeycomb rotor heated by the desorbing zone.

By rotating the above-mentioned honeycomb rotor, the rotor circulates the adsorbing zone, the desorbing zone and the cooling zone in alternatively. Thereby, cycles of adsorbing humidity in normal temperature and desorbing by heat are performed alternatively in repeatedly.

The desorbing process is performed by passing the honeycomb rotor after open air is heated by a heater or a thermal exchanger.

Necessary temperature by heating the air is determined by considering amount of adsorbing humidity of honeycomb rotor and necessary energy (desorbing energy) to desorb humidity from the honeycomb rotor.

The desorbing energy is expressed by product of desorbing temperature and air volume. Thereby, when the amount of humidity is the same, the desorbing energy is lower, then the desorbing temperature and the air volume is more smaller.

In the above mentioned heating temperature of the honeycomb rotor, there is a certain limit by used heater or heat exchanger of the capability or utility (availability of heat source or electricity or the like). In particularly, when an amount of humidity is much, more desorbing energy is necessary. When desorbing air volume increases a desorbing energy, efficiency of a post process step deteriorates, and there is a troublesome that necessary equipment is jumboize or usage of utility increases.

Preferably, zeolite is used as a humidity adsorbent agent (desiccant agent), by means of hitherto hydrophilic zeolite is stronger than silica gel respect to capability of adsorbing humidity. However, the hydrophilic zeolite has drawbacks that it can not exert a capability of an adsorbing humidity so that 180-200° C. of temperature of desorbing is relatively higher because of a heat of vaporization of zeolite is large. Thereby, hitherto zeolite is limited in particular destination e.g. plastic drier or the like.

Alternatively, silica gel knows as an adsorbing humidity agent. Silica gel is lower than zeolite for a desorbing temperature of humidity is 80-150° C. However, in a case of low humidity and when a temperature of air supplied in the honeycomb rotor is high, silica gel has drawbacks that capability of adsorbing humidity can not fully act.

### SUMMARY OF THE INVENTION

In view of the foregoing problems, it is an object of the present invention to provide mainly a humidity adsorbent agent having merits of hydrophilic zeolite and silica gel, that is, a humidity adsorbent agent having an equivalency of the humidity adsorbing capability and the desorbing temperature of the zeolite.

According to the first aspect of the present invention, for achieving the above-mentioned objects, inventors recognized that alumino-silicates replacing a part of sodium in a hydrophilic zeolite to lanthanides are provided prefer humidity adsorbing agent, and the present invention performed in basis of the recognition.

The alumino-silicates used the present invention will be described below.

In general, a crystalline alumino-silicate(s) expressed in xM_{2/n} Al₂O₃ySiO₂ (M is a metal having n value) by differencing of x and y differs a tunnel structure of the crystalline structure, and alumino-silicates are many kind. In these alumino-silicates, the present invention can be used an alumino-silicate structure each of A type zeoite (Na₂O.Al₂O₃.2SiO₂.4.5H₂O), X type zeolite (Na₂O.Al₂O₃.2.5SiO₂.3H₂O) and Y type zeolite (Na₂O.Al₂O₃. 4.8SiO₂. 8.9H₂O) is replaced a part of Na to any of Lanthanides of La mainly. Used materials of the present invention is expressed in formula of aMₓO_{y}. bNa₂O.cAl₂O₃.d SiO₂.eH₂O (M is a Lanthanide).

In the present invention, a Lanthanide(s) which is replaced a part of Na in the zeolite to Lanthanide(s) element is selected any one of Lanthanides or, a plural elements of selected any of Lanthanide.

In the present invention, there is an acknowledge about that the alumino-silicate which structure is replaced to Lanthanide(s) of La mainly, has a low heat of adsorbing and a low heat of vaporization, and an effective adsorbing volume of the alumino-silicate is large for heat of adsorbing and heat of vaporization nearly equal.

These acknowledge means that a humidity adsorbing agent according to the present invention has a high capability of humidity adsorbent from low temperature to high temperature same as hitherto hydrophilic zeolite, and acts dehumidification performance having a desorbing temperature same as silica gel.

That is, according to the first aspect of the present invention, for achieving the above-mentioned objects, there is a substance of being used an alumino-silicate which is replaced a part of sodium to Lanthanide(s) in a hydrophilic zeolite.

According to the second aspect of the present invention, in the first aspect of the present invention, there is a substance that the humidity adsorbing agent is an alumino-silicate which is expressed in formula of aMₓO_{y}.bNa₂O. cAl₂O₃.dSiO₂.eH₂O (M is a Lanthanide), the Lanthanide is selected any one of Lanthanides or, a plural elements of selected any of Lanthanide.

According to the third aspect of the present invention, in the second aspect of the present invention, there is a substance that in the humidity adsorbing agent, aMₓO_{y} is selected one or more in La₂O₃, Nd₂O₃, CeO₃ and Pr₆O₁₁, Na₂O is a ratio of equal to or less than 5 weight %, Al₂O₃ is a ratio of 10 to 35 weight % as the cAl₂O₃ and SiO₂ is a ratio of 20 to 80 weight % as the d SiO₂.

According to the fourth aspect of the present invention, in the first to third aspects of the present invention, there is a substance that a humidity adsorbing element is supported the humidity adsorbing agent on a carrier.

It is preferred that for an object capability is performed, aMₓO_{Y} contains equal to or more than 1 weight %. In aMₓO_{y}, there is a most preferably that La₂O₃ used, when more effectively is obtained, there is more preferred that La₂O₃ is contained a ratio of 4 to 10 weight %.

Upper limit of La₂O₃, CeO₃ and Pr₆O₁₁ is in generally, 10 weight % in La₂O₃, about 5 weight % in Nd₂O₃, CeO₃ and Pr₆O₁₁, respectively. In the present invention, it is not limited these contains, more ratio contains may be used.

Performing a good dehumidify capability of the humidity adsorbent element of the present invention, it is preferred that necessity of a capacity of honeycomb rotor is equal to or less than 250 g/litter, more preferably, 200 g/litter.

### DESCRIPTION OF THE PREFERRED EMBODIMENTS

In a preferred embodiment of a present invention, inorganic binder was added in an adsorbing agent containing of 6 weight (wt) % of La₂O₃, 2 wt % of Nd₂O₃, 2 wt % of CeO₃, 2 wt % of Pr₆O₁₁, 27 wt % of Al₂O₃ and 58 wt % of SiO₂ and was slurry likewise, then a surface of honeycomb rotor was impregnated in the slurry and dried. A humidity adsorbing element was constituted.

### EXAMPLE

Example of the present invention with comparative examples will be described below.

### Example 1

As a material which was added a minority of organic fiber in a major of alumino-silica fiber as raw material, paper was made having a thickness of 0.2 mm, a density of 0.25 g/cm³. Obtained raw material paper was used and corrugate-manufactured as honeycomb likewise 3.3 mm in each length and 1.9 mm in each width and rolled, then obtained fabrics had a cylindrical honeycomb structure (400 mm in diameter, 400 mm in length). The honeycomb structure was impregnated in a slurry likewise adding inorganic binder in the humidity adsorbent agent comprised of La containing alumino-silicate composition of 6 weight (wt) % of La₂O₃, 3 wt % of Na₂O, 2 wt % 58 wt % of of Nd₂O₃, 2 wt % of CeO₃, 2 wt % of Pr₆O₁₁, 27 wt % of Al₂O₃ and 58 SiO₂, and dried then removed in organic part of the honeycomb structure by baking. A humidity adsorbing element of honeycomb likewise was obtained.

### Comparative example 1

Using a same manufacturing method of example 1, a humidity adsorbent element of a cylindrical honeycomb structure (400 mm in diameter, 400 mm in length) supported A type zeolite was obtained.

### Comparative example 2

E glass fiber paper (30 g/m² in basic weight of square meter, 0.2 mm in thickness) was impregnated in a slurry likewise. Obtained raw material paper was used and corrugate-manufactured as honeycomb likewise 3.3 mm in each upper peak pitch and 1.9 mm in height, then obtained fabrics had a cylindrical honeycomb structure (400 mm in diameter, 400 mm in length). After the honeycomb structure was impregnated in sodium silicate solution, silica gel on the honeycomb surface was synthesized by chemical reaction. Then it was washed, dried, and was removed organic in honeycomb humidity adsorbent element and a humidity adsorbent element supported silica gel of honeycomb likewise was obtained.

The honeycomb likewise humidity adsorbent element manufactured by using method same of example 1, comparative examples 1 to 2, was set in a rotary regeneration type dehumidifier. Obtained result is shown by Tables 1 to 2.

Table 1 shows dew point of processing outlet is compared in example 1 and comparative examples 1 to 2. Table 2 shows regenerating temperature which the same dew point of processing outlet is obtained in example 1 and comparative example 1 compares.

TABLE 1

| inlet temperature | | 10° C. | 20° C. |
|---|---|---|---|
| inlet absolute moisture | | 5 g/kg | 5 g/kg |
| outlet dew | Example 1 | −56° C. DP | −45° C. DP |
| point | | | |
| | Comp. | −43° C. DP | −35° C. DP |
| | example 1 | | |
| | Comp. | −38° C. DP | −28° C. DP |
| | example 2 | | |

Testing condition: passing wind speed 2 m/s;
regenerating temperature 140° C.;
° C. DP: dew point (dew point by ° C.)

TABLE 2

| | Example 1 | Comp. example 1 |
|---|---|---|
| regeneration | 140° C. | 160° C. |
| temperature | | |
| outlet dew point | −53° C. DP | −53° C. DP |

Testing condition: passing wind speed 2 m/s;
processing inlet temperature 10° C.;
processing inlet absolute moisture 5 g/kg

It is clearly shown by Tables 1 to 2, by using a humidity adsorbent element supported a humidity adsorbent agent according to the present invention, a humidity adsorbent capability is larger as same as in conventional a humidity adsorbent agent using silica gel. To use of dehumidification used hydrophilic zeolite under low humidity area, upgrade performance of dehumidification humidification and lowering of desorbing energy can be performed.

In addition, desorbing temperature for necessary gain of humidity adsorbing capacity (performance of dehumidification, humidification) same as humidity adsorbent agent using silica gel can be small. These effects increases by maldistributing a humidity adsorbent agent(s) on carrier surface supported.

Furthermore, low temperature area such as hydrophilic zeolite utilizes merely may use and usage method of waste heat is conceivable. These effects increases by maldistributing a humidity adsorbent agent(s) on carrier surface supported.

Thereinbefore, describing the present invention in detail, in accordance with the present invention, there is provided a humidity adsorbent agent having duplicating advantages of hydrophilic zeolite and silica gel, that is, there is provided a humidity adsorbent agent having a humidity adsorbent capability same as zeolite and desorbing temperature is the same of silica gel and there is provided a humidity adsorbing element using thereof.

What is claimed is:

1. A humidity adsorbent agent used an alumino-silicate which is replaced a part of sodium to Lanthanide in a hydrophilic zeolite.

2. The humidity adsorbent agent claimed in claim 1, wherein the humidity adsorbing agent is an alumino-silicate which is expressed in formula of aMₓO_{y}.bNa₂O.cAl₂O₃.d SiO₂.eH₂O (M is a Lanthanide), the Lanthanide is selected any one of Lanthanides or, a plural elements of selected any of Lanthanide.

3. The humidity adsorbent agent claimed in claim 2, wherein the aMₓO_{y} is selected one or more in La₂O₃, Nd₂O₃, CeO₃ and Pr₆O₁₁, Na₂O is ratio of equal to or less than 5 weight % as bNa₂O, Al₂O₃ is ratio of 10 to 35 weight % as the cAl₂O₃, and SiO₂ is a ratio of 20 to 80 weight % as the dSiO₂.

4. A humidity adsorbing element wherein the humidity adsorbing agent claimed in claims 1 to 3 is supported on a carrier.
